(19) United States
(12) Patent Application Publication
(10) Pub. No.: US 2014/0355947 A1
(43) Pub. Date: Dec. 4, 2014

(54) SYSTEM AND METHOD FOR SYNCHRONIZING MULTI-CAMERA MOBILE VIDEO RECORDING DEVICES

(71) Applicants: Alois William Slamecka, Atlanta, GA (US); Michael Scott Bryant, Roswell, GA (US)

(72) Inventors: Alois William Slamecka, Atlanta, GA (US); Michael Scott Bryant, Roswell, GA (US)

(21) Appl. No.: 14/215,030

(22) Filed: Mar. 16, 2014

Related U.S. Application Data
(60) Provisional application No. 61/801,710, filed on Mar. 15, 2013.

(51) Int. Cl. H04N 5/91

(52) U.S. Cl. CPC H04N 5/91
USPC 386/201

(57) ABSTRACT

System and method for synchronizing mobile recording devices for creation of a multi-camera video asset including a mobile recording device, master and slave wireless media sync devices, cloud storage system, video registry, and media management application. Exemplary embodiments provide for timing precision over current methods. Precise time-code within each device is provided without constant inter-device communication. Video is captured on each mobile video capture device without knowledge, control by other devices. A common audio signal is sent to mobile video capture devices over wireless network of sync devices. Audio waveform captured with video is identical on each device, adding an additional accuracy factor, which works in combination with time-code to improve synchronization of multi-camera mobile video capture system. Each recording device registers its recording event on network based server, so that a list may be assembled of recording devices and unique name may be added to recording by each device.

### RELATED APPLICATION

This application claims priority to and the benefit of the prior filed co-pending and commonly owned provisional application entitled “System and Method for Synchronizing Multi-Camera Mobile Video Recording Devices” which was filed with the United States Patent and Trademark Office on Mar. 15, 2013, assigned U.S. Patent Application Ser. No. 61/801,719, and is incorporated herein by this reference.

### FIELD OF THE INVENTION

The invention relates generally to the field of multi-source media management, and particularly to the systems and methods necessary to detect video sources, provide a reference audio source, and provide a synchronization method by which each source can be managed in real-time, and subsequently aligned for the purpose of creating a composite multi-camera video asset.

### BACKGROUND

The capture of an event or performance using multiple video capture devices requires precise synchronization of all video sources and audio sources to produce a composite audio/video broadcast or recorded asset. A variance greater than 60 milliseconds between audio and video in the composite asset is noticeable by the viewer and often described as a ‘lip sync’ problem rendering the asset unwatchable.

Modern professional audio and video recording devices do not contain inter-device communication capabilities that allows for device-to-device auto-synchronization, relying instead on a hard wired means to establish synchronization. By introducing a highly accurate master clock signal and time code that is inter-locked and distributed over a wireless network, each mobile media recoding device can be seamlessly aligned. This alignment results in a common time base which can be easily used for mixing and editing device assets in real-time (broadcast) or offline (post-production) with a high degree of precision.

The equipment required for synchronizing multiple A/V devices using the current technology is complex and costly, limiting its use to the professional market. This leaves a growing segment of the market under-served and unable to take full advantage of the media recording capabilities of their mobile devices. Consumer mobile video capture devices created an explosion in user-generated content (UGC) and are responsible for the increasing user demand for more sophisticated capabilities. In parallel with this user demand, UGC video websites such as YouTube, Vimeo, and others are actively seeking longer-form, professional quality UGC content from this growing market segment.

Today's consumer mobile video capture devices contain professional quality, high definition video features however they have no self-contained capability to synchronize internal video clips or video between multiple devices. Mobile video capture devices capture discrete videos without a reference time-code. Each video starts at 0 minutes, 0 seconds. The lack of a reference time-code makes it impossible to align videos using a time-code not only between mobile devices but also within a single device as there is nothing in the video that provides a relative time base within the event being recorded.

As a mobile device begins to record a video, it initializes each video at 0 min, 0 sec, as if it were not related to any other video on the device or on another device. It is therefore necessary to create a system and method for providing each video recording instance on any mobile device within a venue with the same time code reference that can be embedded in the media.

Professional post-production applications such as Apple's Final Cut Pro employ a number of techniques to achieve an equivalent synchronization of assets that do not contain a reference time-code. These tools however require knowledge, time, and financial investment that are not suited to a consumer desiring to create a multi-camera asset, ideally using an application natively on the mobile device. The success of these techniques also varies, as none have proven as dependable as an accurate reference time-code.

Current mobile device video capture applications are also not capable of synchronizing videos with the precision needed to avoid gaps during audio/video playback or causing audio/video ‘lip sync’ issues. Attempts to mitigate this problem have been made by using audio waveform matching. This technique can be affected by environmental variables which make the matching less precise and open to error.

Current state of the art systems such as Apptopus Inc.'s CollabraCam for Apple iOS devices are limited by requiring central control over mobile devices. Each mobile device registers itself with a central device that controls the capture of video sequentially. When the central device sends a command to stop recording to one device, it sends a command simultaneously to another to start recording. The system is constrained by its use of WLAN (e.g. wi-fi) as the communication medium for sending commands. WLAN is not a deterministic medium so commands sent simultaneously to two different devices are often received at different times and therefore not perfectly synchronized. The central device assembles the composite asset by adding each video in the order captured, however gaps or overlaps between sequential videos often occur due to one camera starting or stopping too late. The system also has no control over when messages are received by the remote devices. Since each mobile device captures video when instructed to, the composite asset must follow that order negating the opportunity to improve the asset in post-production. As will be seen in the current invention these flaws are mitigated and each mobile device may record at will with no knowledge of the other devices.

Another method of synchronization is provided by Vjay of Algoriddim (Germany) using post editing methods. Synchronization is accomplished by time analyzing the audio within each to estimate the approximate beats-per-minute (BPM) of the audio track. The system may determine the same BPM from two videos of the same event however it has no mechanism to time-align the videos. Due to the inability to provide precise time-alignment, Vjay is primarily used to create composite assets where video and audio are not related to each other.

### SUMMARY

The invention provides efficient and simple methods for timing precision over the current methods described above, which have limited ability to control the variables they use to establish synchronization of multi-camera videos. One method of the invention generates precise time-code within each device without requiring constant inter-device communication. Video is captured on each mobile video capture device without any knowledge or required control by other devices. Another method of the invention allows a common audio signal to be sent to mobile video capture devices over the wireless network of sync devices. The audio waveform captured with the video is identical on each device, adding an additional accuracy factor works in combination with time-code to further improve synchronization of the overall multi-camera mobile video capture system. Furthermore, a method is employed for each recording device to register it's recording event on a network based server, so that a list may be assembled of recording devices and a unique name may be added to the recording by each device.

It is necessary to find a suitable means of mobile video capture device synchronization that does not rely solely on audio waveform matching and with sufficient precision to eliminate detectable timing variance across any combination of participating mobile video capture devices. As will be shown in the subsequent description, a new method for the introduction of a reference time-code across multiple mobile video capture devices will provide the resolution and common time-base required for real-time or post-production synchronization, where a location based marking system will be used to identify associated video recordings.

In the exemplary embodiment a master, slave network of wirelessly aligned media sync devices establish a frequency matched network of clocks used to provide a common time code at each mobile device. Once aligned, the clocks on each media sync device run with a high degree of precision with regard to each other. A time-stamp is then acquired by the media sync devices from a reference time source (e.g. NTP server) as a means to set the reference time-code. NTP is a well known method for obtaining a Universal Time Code over a packet based network such as the Internet.

By setting the frequency of the sync devices to match the industry-standard sampling rate for CD audio (44.1 kHz), the sync devices serve two critical purposes: 1) to increment the reference time-code for video capture applications on the mobile devices and 2) to support the capture of a common audio signal over the wireless network. These functions enable a common time-code for all the videos captured by the mobile devices and a common audio waveform captured with each video. This combination enables precise synchronization of video assets when assembled into a composite asset in a broadcast or post-production environment.

In addition to the time code distribution to each media sync device, a mechanism is provided for the discovery of other recording devices, registration of the event, and marking of the video on each device with a unique identifier for the event so that all related recorded media can be assembled on a mobile device, cloud storage system or computer equipped with an editor.

A video management application is also provided on the mobile video recording device, as a means to engage the wireless media sync device, to retrieve a time code base and synchronized audio, to control the video recording, and save the time encoded video and communicate with the video registration server on the cloud storage system.

### BRIEF DESCRIPTION OF THE DRAWINGS

FIG. 1 is a system diagram of the exemplary embodiment of the invention for a multi-camera recording event.

FIG. 2 is a high level component diagram of an exemplary wireless media sync device

FIG. 3 is a flow diagram depicting the steps used in an exemplary method for synchronizing the time code between a master and slave wireless sync devices.

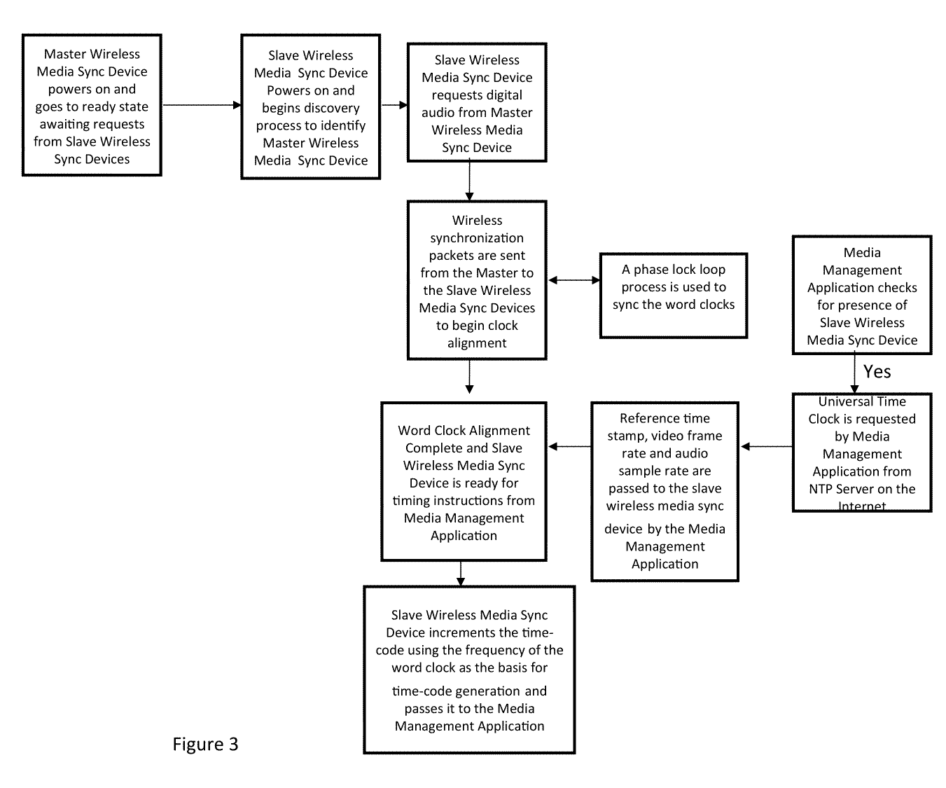

FIG. 4 is a flow diagram of the steps used in an exemplary method for creating and registering a synchronized video on a mobile recording device.

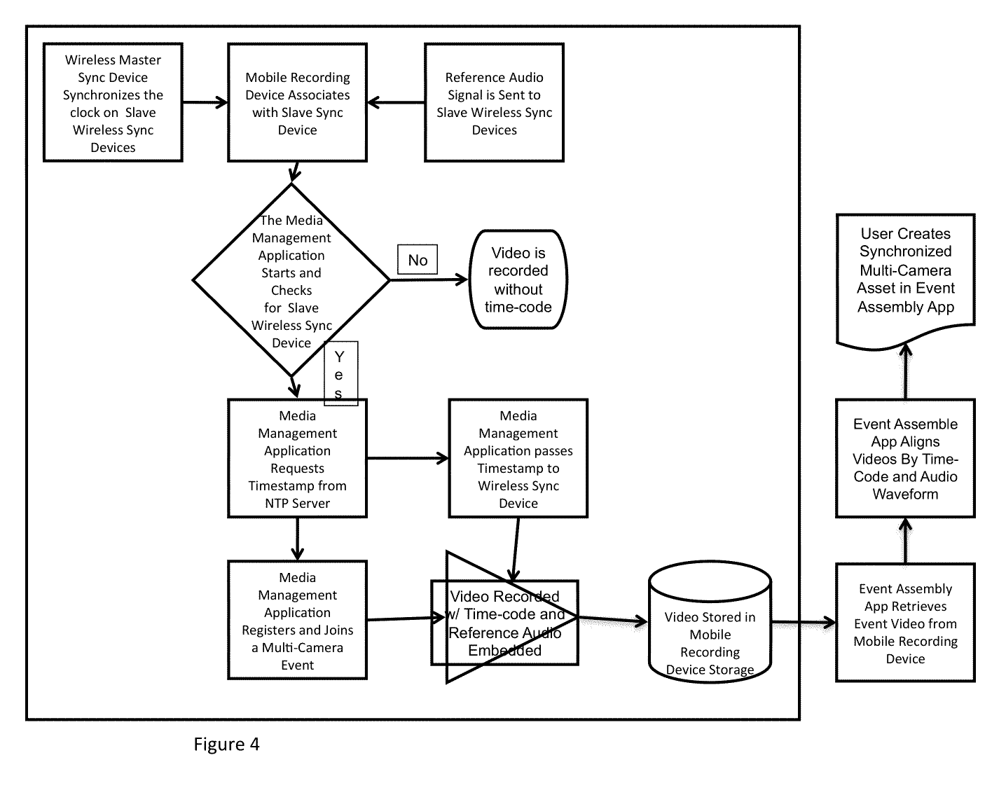

### DETAILED DESCRIPTION

Generally stated, the invention relates to a system for synchronization and management of mobile video capture devices for the purpose of creating a multi-camera video asset of a captured event or performance. An exemplary embodiment provides for the introduction of a common time-code across mobile video capture devices and capture of a reference audio source enabling highly accurate assembly of a synchronized video asset with high quality audio. Features and actions of the exemplary embodiments allow synchronization with a high degree of accuracy utilizing wireless communications and native applications on the mobile devices, without costly external components and expensive post-production software; none of which was possible using prior art systems and methods as explained below.

The invention is not limited to a specific type of mobile video capture device and may be applied to any type of intelligent mobile device that has video recording capability. It is also not limited to the activity of video capture and may be applied to any intelligent mobile device use that requires highly accurate time-based synchronization. Furthermore, it is anticipated that future mobile recording devices may incorporate the media sync device functionality as an integral component thereby further reducing the cost to the end user.

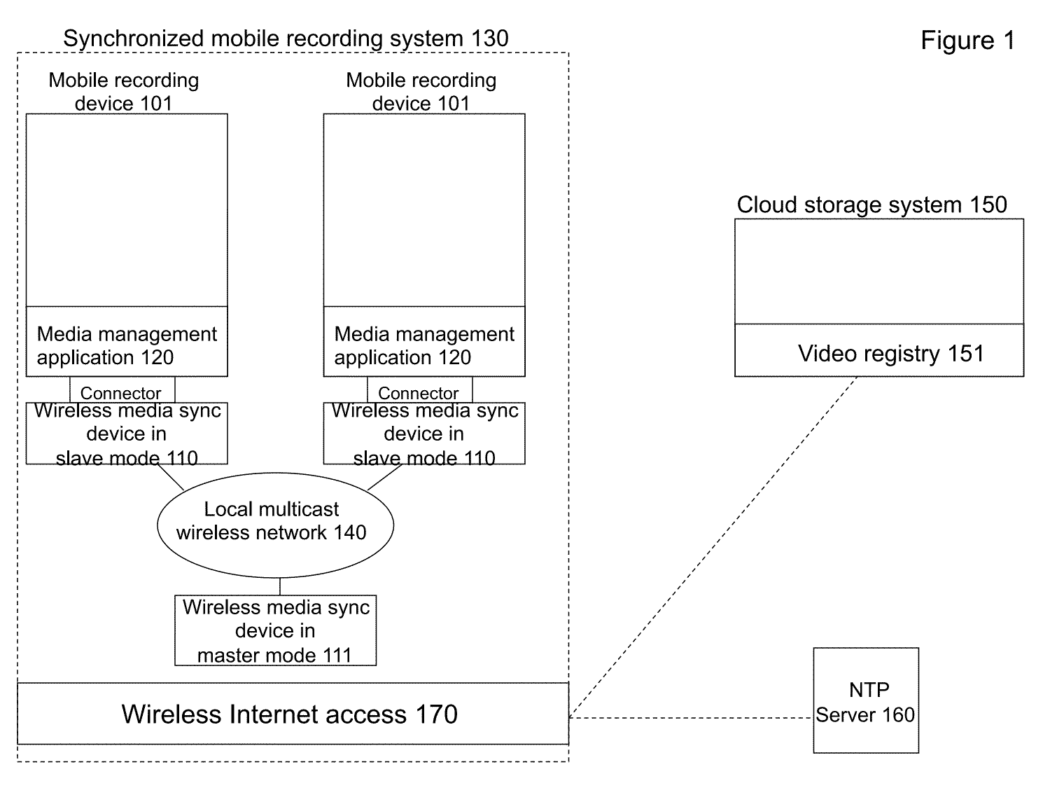

The exemplary embodiment shown in FIG. 1 contains multiple mobile recording devices 101, wireless media sync devices in slave mode 110, synchronized mobile recording systems 130, media management applications 120, a wireless media sync device in master mode 111, a cloud storage system 150, containing a video registry 151, a local multicast wireless network between media sync devices 140, an NTP server 160 to provide a time stamp, and wireless Internet access 170 to the cloud storage system 150.

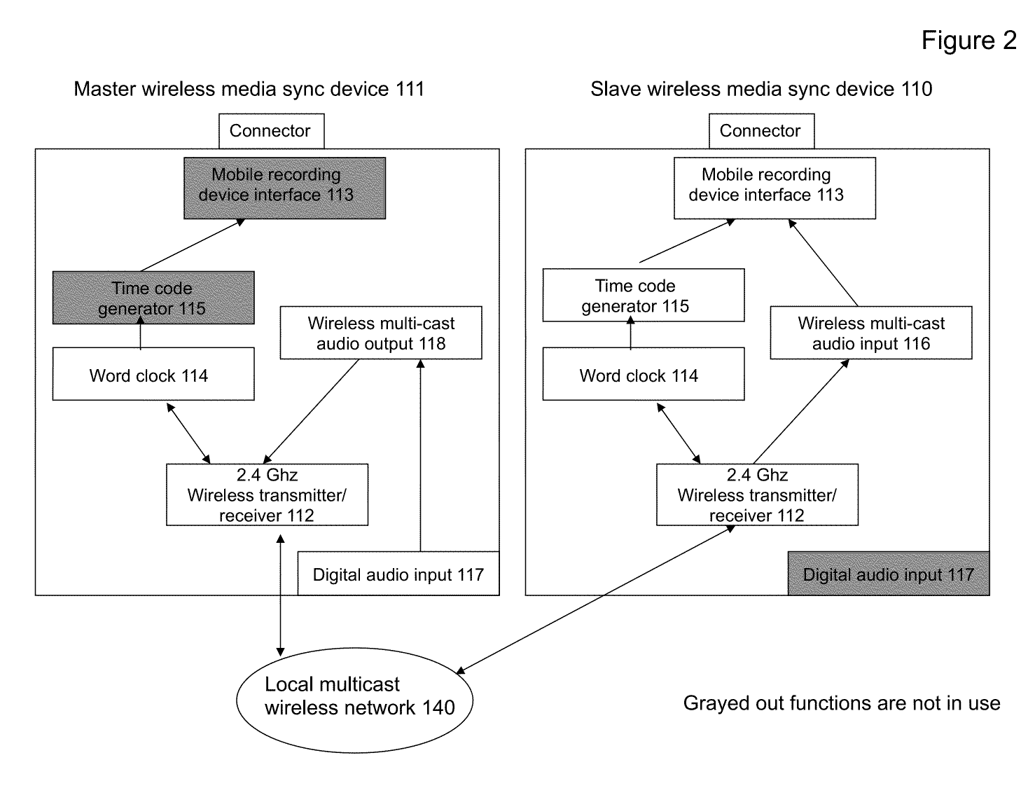

In FIG. 2 an exemplary embodiment of a slave and master wireless media sync devices. The slave wireless media sync device 110 is shown comprising a wireless transmitter/receiver 112, mobile recording device interface 113, word clock 114, time code generator 115, multi-cast wireless audio receiver 116, and digital audio input 117. The master wireless media sync device 111 has the same exact same internal components, except that the digital audio input 117 is enabled (given source audio is connected) and multi-cast wireless audio transmitter 118 are turned on rather than the receiver 116 side of the unit. The mobile recording device interface 113 and time code generator 115 are not in use when in this mode.

Referring to FIG. 1, the wireless media sync devices in slave mode 110 perform a discovery mechanism to request multi-cast for the audio source being transmitted by the master wireless media device in master mode 111 on power up. Once a wireless link is established between the master 111 and the slave 110 wireless media sync devices, a set of synchronization packets are transmitted to each slave wireless media sync device 110 to adjust the slave wireless media sync device 110 word clocks 114 at 44.1 kHz. This frequency is used in order to match the frequency of an external digital audio signal that may also be sent from the wireless media sync device in master mode 111 to the wireless media sync device in slave mode 110. Word clock 114 synchronization is accomplished via a phase locked loop process that matches the frequency of the wireless media sync device in master mode 111 and wireless media sync device in slave mode 110 clocks with sufficient accuracy to have very low jitter. This process establishes word clock 114 alignment across the slave wireless media sync devices 110.

Once aligned, the slave wireless media sync devices 110 are each associated with a mobile recording device 101 to form a synchronized mobile recording system 130. This is typically done by connecting the sync device to an input/output (I/O) connection on the mobile recording device. With a synchronized mobile recording system 130, now ready, media management application 120 can be activated to begin preparation for video capture. At the start of a video capture event, media management application 120 locates a network time protocol (NTP) server(s) 160 via the wireless Internet access 170 and captures a reference time stamp that accounts for propagation delays to/from the NTP server(s). The reference time stamp, video frame rate and audio sample rate are passed to the slave wireless media sync device 110 associated with the mobile recording device 101 by the media management application 120. The slave wireless media sync device 110 then starts to increment the time-code using the frequency of the work clock as the basis for time-code generation. This is accomplished by calculating the number of word clock 114 samples that make up one frame of video.

In the operative field of the invention, mobile video capture devices record videos with up to 1080p pixel resolution (1920×1080 pixels) at a rate of 24, 25, or 30 video frames per second and audio is simultaneously recorded at either 44.1 k or 48 k samples per second, with specific settings determined by the device or an application. Video time-code follows an industry-standard format enumerated in Hours:Minutes:Seconds:Frames (H:M:S:F). The metadata associated with recorded video files informs the mobile recording device 101 and media management application 120 of the embedded time code.

The exemplary embodiment of the invention uses standard time-code notation, accommodating different video frame and audio sample rates, and storing individual and composite video assets on the mobile recording device 101 native storage system. Using digital video's (DV) 30-frames-per-second as an example, each video frame is 0.03333 seconds in duration. To increment the time-code by one frame, the duration of a video frame must be translated to word clock 114 samples on the sync device. Assuming 44.1 kHz as the word clock 114 sample rate, one frame of video is equivalent to 1469.71 word clock 114 samples. With a precision word clock 114 on the wireless media sync device in slave mode 110, time-code is incremented frame-by-frame with high accuracy.

The video capture begins on the mobile recording device 101 once time-code is incremented by the slave wireless media sync device 110. The media management application 120 embeds the time-code in the recorded asset. Stopping and starting video capture does not create a problem, as an accurate reference time-code will be captured with each video segment. Videos from mobile recording device 101 recording the same event may be aggregated into an environment where they are aligned to the reference timeline based on the time code and made available for the creation of a multi-camera composite asset. This can be done by native applications on the mobile recording device 101 themselves, a desktop application, a cloud application, or other means to assemble or auto-assemble a composite video asset.

Before the start of any recording, the media management application 120 initially checks for the presence of the wireless media sync device in slave mode 110 to determine whether video will be captured with a reference time-code and/or reference audio signal. If no device is detected then video is captured without time-code or external audio. If a wireless media sync device in slave mode 110 device is detected, the media management application 120 initializes a timestamp request from an external NTP reference timeserver using the NTP protocol. Across the network of mobile recording device 101, the timestamp is accurate to within one tenth of a second. The timestamp is passed to the wireless media sync device in slave mode 110 which begins generating time-code by incrementing the timestamp. A firmware application on the wireless media sync device in slave mode 110 converts clock cycles into a reference for incrementing the time-code one frame at a time. The wireless media sync device in slave mode 110 continues to generate time-code until it received a new time-stamp from the application or it is powered off.

The media management application 120 requests and receives the time-code stream from the wireless media sync device in slave mode 110 which is then embedded into the video file once recording begins. If a reference audio signal is being sent to the wireless media sync device in slave mode 110, the media management application 120 captures the audio track in the video. The video asset is then saved on the mobile recording device 101 local storage. Transfer of the video assets can then be made by means well known in the art and complied in the cloud storage or another location more convenient for the post asset editing and assembly.

In parallel to requesting the time-stamp, the media management application 120 registers the event on the a cloud storage system 150 that contains a video registry 151, by sending the GPS coordinates, NTP, and mobile recording device 101 name for each video segment that is recorded. This method ensures that a unique identifier is associated with each recording's registration, and that each device's recorded segments can be requested and assembled easily in a post production video system. In situations where the media management application 120 is unable to gather GPS, the video registry 151 will save the public IP of the sending mobile recording device 101 as an alternate means of associative location.

This process occurs for all the mobile recording devices 101 that are using the wireless media sync device in slave mode 110. The process of synchronized multi-camera asset creation includes the process of asset selection, alignment, and assembly after the event has ended. At the conclusion of the event, the recorded assets maybe aggregated by an event assembly application, which may be part of the media management application 120 or located as a standalone application residing on another computing device, a tablet, a computer, or in the cloud. The event assembly application user creates the multi-camera asset by selecting desired cameras during real-time playback. The edited asset is stored as a video file. Alternately, all the assets can be procured and edited in any post-production software tool. The embedded time-code ensures synchronization of all the videos in off the shelf applications.

Another advantage of the invention is that it enables audio waveform analysis by the event assembly application to verify or correct any anomalies that may occur with the time-code. The accuracy of audio waveform analysis depends on the similarity of the waveforms captured by each device.

The reference audio signal through the wireless media sync device in slave mode 110 provide the same waveform for each video and is optimized to capture only the event performance without background noise or proximity issues caused by the distance between the microphone and the audio source. Audio waveform analysis however is generally not sufficient alone to synchronize multiple mobile video recordings because a recording may be short enough to capture a section of the audio (e.g. music) which is repeated (especially common with repetitive beat-oriented music genres), making it difficult to place in the video timeline. Therefore, it is used as a secondary method to verify and correct any time-code anomalies.

A person of ordinary skill in the art understands the devices and methods with which the invention operates. To refresh this understanding, reference may be made to any of the following, which are incorporated herein by reference: Smartphone, from Wikipedia found at http://en.wikipedia.org/wiki/Smartphone as of Mar. 15, 2013; Lydon, et al., U.S. Pat. No. 8,386,677; Song, et al., United States Patent Publication No. US 2013/0067027 A1; and Yerrace et al., United States Patent Publication No. US 2013/0064386.

We claim:

1. A system for synchronizing mobile recording devices for the creation of a multi-camera video asset, comprising:
a mobile recording device;
master and slave wireless media sync devices;
cloud storage system;
video registry; and
media management application

2. A method for providing highly accurate wireless synchronization of wireless media sync device clocks on a wireless local area network.
